(19) United States
(12) Patent Application Publication
(10) Pub. No.: US 2010/0202756 A1
(43) Pub. Date: Aug. 12, 2010

(54) MOVING IMAGE PROCESSING APPARATUS AND REPRODUCTION TIME OFFSET METHOD

(76) Inventor: Takeshi Kodaka, Kamakura-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/563,535

(22) Filed: Sep. 21, 2009

(30) Foreign Application Priority Data
Feb. 10, 2009 (JP) 2009-028801

(51) Int. Cl. H04N 5/91; H04N 7/12

(52) U.S. Cl. 386/95; 375/240.03; 375/240.2; 375/240.16; 375/E07.139; 375/E07.226; 386/E05.001

(57) ABSTRACT

A moving image processing apparatus comprises a moving image encoder which outputs the motion vectors of an encode frame, a reproduction time changing unit which, on the basis of the motion vectors, determines a motion quantity between a moving image frame with the motion vectors and the preceding moving image frame and calculates an offset for a reproduction time, a reproduction time generating device which generates a reproduction time of a target frame from a reference time and the offset for the reproduction time, and a reproduction time adding device which adds the reproduction time generated at the reproduction time generating device to moving image data output and encoded by the moving image encoder.

### CROSS-REFERENCE TO RELATED APPLICATIONS

This application is based upon and claims the benefit of priority from prior Japanese Patent Application No. 2009-028801, filed Feb. 10, 2009, the entire contents of which are incorporated herein by reference.

### BACKGROUND OF THE INVENTION

1. Field of the Invention

This invention relates to a moving picture processing apparatus and a reproduction time offset method and may be applied to, for example, a video apparatus or a moving image edit apparatus.

2. Description of the Related Art

Some moving image processing apparatuses, such as video units, change the moving image reproduction time on the basis of a screen rate (the number of images displayed per second) in video shooting (refer to, for example, Jpn. Pat. Appln. KOKAI Publication No. 2007-312006).

However, in normal video shooting, the screen rate is kept constant. Therefore, in normal video shooting where temporally rapid movements, such as rapid pan operations involving rapid screen movements, or camera shakes during the shooting while moving at a constant speed cannot be uniformized by conventional techniques.

### BRIEF SUMMARY OF THE INVENTION

According to an aspect of the invention, there is provided a moving image processing apparatus comprising: a moving image encoder which outputs the motion vectors of an encode frame; a reproduction time changing unit which, on the basis of the motion vectors, determines a motion quantity between a moving image frame with the motion vectors and the preceding moving image frame and calculates an offset for a reproduction time; a reproduction time generating device which generates a reproduction time of a target frame from a reference time and the offset for the reproduction time; and a reproduction time adding device which adds the reproduction time generated at the reproduction time generating device to moving image data output and encoded by the moving image encoder.

According to another aspect of the invention, there is provided a moving image processing apparatus comprising: a moving image encoder which outputs the motion vectors of an encode frame; a reproduction time changing unit which, on the basis of the motion vectors, determines a motion quantity between a moving image frame with the motion vector and the preceding moving image frame and calculates an offset for a reproduction time and which has a threshold value for a motion quantity input from outside and, if a motion quantity is less than the value obtained by subtracting a leading offset from the input threshold value, outputs an offset value to set the time in shooting forward; a reproduction time generating device which generates a reproduction time of a target frame from a reference time and the offset for the reproduction time; and a reproduction time adding device which adds the reproduction time generated at the reproduction time generating device to moving image data output and encoded by the moving image encoder.

According to still another aspect of the invention, there is provided a reproduction time offset method using a reproduction time generating device with an offset computing unit, the reproduction time offset method comprising: calculating a difference averaged motion vector by subtracting an averaged motion vector of the preceding frame from an averaged motion vector of the present frame; determining whether the difference averaged motion vector exceeds an externally specified difference threshold value; and, if the difference averaged motion vector exceeds the externally specified difference threshold value, adding a unit-time delay as a reproduction time change offset recording value.

### BRIEF DESCRIPTION OF THE SEVERAL VIEWS OF THE DRAWING

FIG. 1 is a block diagram showing an overall configuration of a moving image processing apparatus according to a first embodiment of the invention;

FIG. 2 is a block diagram showing a configuration of a reproduction time generating device according to the first embodiment;

FIG. 3 is a flowchart to explain the operation of a vector aggregating unit according to the first embodiment;

FIG. 4 is a flowchart to explain the operation of a reproduction time offset computing unit according to the first embodiment;

FIG. 5 is a timing chart to explain the decode output of the moving image processing apparatus according to the first embodiment;

FIG. 6 is a flowchart to explain the operation of a reproduction time offset computing unit according to a second embodiment of the invention; and

FIG. 7 is a timing chart to explain the decode output of the moving image processing apparatus according to the second embodiment.

### DETAILED DESCRIPTION OF THE INVENTION

Hereinafter, referring to the accompanying drawings, embodiments of the invention will be explained. In the explanation, the same parts are indicated by the same reference numerals throughout the drawings.

### First Embodiment

### 1. Configuration

A configuration of a moving image processing apparatus according to a first embodiment of the invention will be explained.

1-1. Overall Configuration

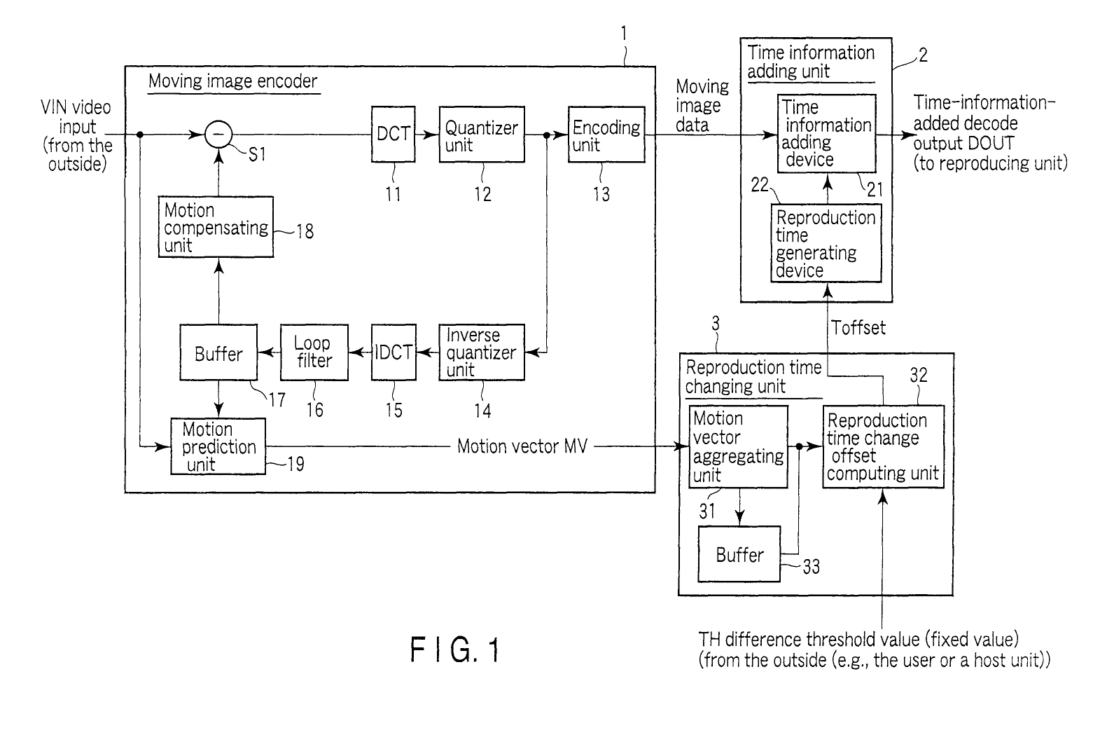

An overall configuration of the moving image processing apparatus according to the first embodiment will be explained with reference to FIG. 1.

As shown in FIG. 1, the moving image processing apparatus comprises a moving image encoder 1, a time information adding unit 2, and a reproduction time changing unit 3.

The moving image encoder 1 calculates a motion vector MV for each macro block (MB) of encode images in the process of encoding the moving images in the externally input video inputs VIN and outputs not only the motion vector to the reproduction time changing unit 3 but also the encoded moving image data to the time information adding unit 2.

The moving image encoder 1 includes a subtractor S1, a discrete cosine transform (DCT) 11, a quantizer unit 12, an coding unit 13, an inverse quantizer unit 14, an inverse discrete cosine transform (IDCT) 15, a loop filter 16, a buffer 17, a motion-compensating unit 18, and a motion prediction unit 19.

The subtractor S1 subtracts the output of the motion-compensating unit 18 from an externally supplied video input VIN and outputs the result.

The DCT 11 subjects the output of the subtractor S1 to discrete cosine transformation and outputs the result.

The quantizer unit 12 quantizes the output of the DTC 11 and outputs the result.

The coding unit 13 codes the output of the quantizer unit 12 and outputs the result. The output encoded by the coding unit 13 is output as coded moving image data to the time information adding unit 21.

The inverse quantizer unit 14 inversely quantizes the output of the quantizer unit 12 and outputs the result.

The IDCT 15 subjects the output of the inverse quantizer unit 14 to inverse discrete cosine transformation and outputs the result.

The loop filter 16 multiplies the output of the IDCT 15 by a fixed value and outputs the result.

The buffer 17 holds the output of the loop filter 16 temporarily.

The motion-compensating unit 18 compensates the output of the buffer 17 and outputs the result to the subtractor S1.

The motion prediction unit 19 receives a video input VIN and the output of the buffer 17 and outputs a motion vectors MVs.

The time information adding unit 2 includes a time information adding device 21 and a reproduction time generating device 22.

The time information adding device 21 receives the encoded moving image data output from the coding unit 13 and the output of the reproduction time generating device 22 and outputs the result as time-information-added encoded output DOUT to an external reproducing unit. The time information adding device 21 adds the time generated by the reproduction time generating device 22 to the output of the encode data and outputs the result. For example, a one-unit-time-delayed time generated at the reproduction time generating device 22 is added to the output of the encode data. The result is output as time-information-added encoded output DOUT to an external unit, such as a reproducing unit.

The reproduction time generating device 22 receives a reproduction time change offset storage value Toffset (hereinafter, referred to as an offset value) output from a reproduction time change offset computing unit 32 and outputs the reproduction time to the time information adding device 21.

The reproduction time changing unit 3 includes a motion vector aggregating unit 31, the reproduction time change offset computing unit 32, and a buffer 33.

The motion vector aggregating unit 31 receives a motion vectors MVs output from the motion prediction unit 19 and outputs the result to the reproduction time change offset computing unit 32 and buffer 33. The motion vector aggregating unit 31 averages the input motion vectors MVs and outputs the averaged motion vector.

The reproduction time change offset computing unit 32 receives the output of the motion vector aggregating unit 31, the output of the buffer 33, and a difference threshold value TH, a fixed value, supplied from the outside (such as a user or a host unit) and outputs an offset signal Toffset to the reproduction time generating device 22.

The buffer 33 holds the output of the motion vector aggregating unit 31 temporarily and outputs the held output as the value at the preceding time to the reproduction time change offset computing unit 32.

1-2. Configuration of Reproduction Time Generating Device

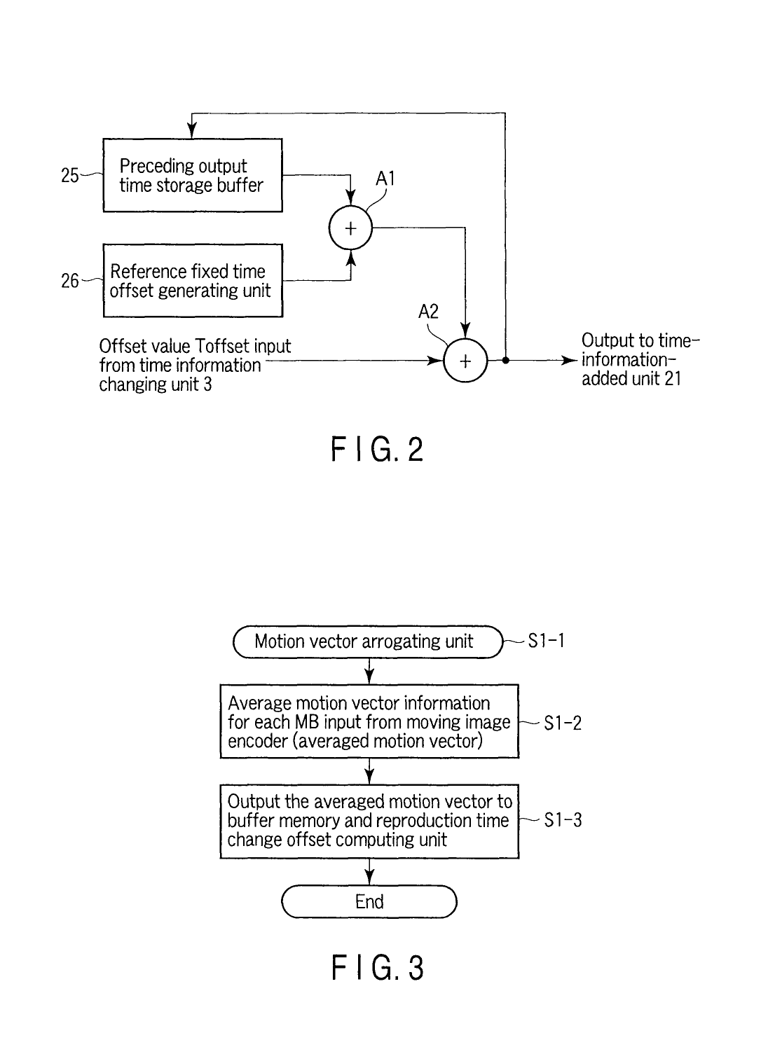

Next, a configuration of the reproduction time generating device 22 will be explained with reference to FIG. 2.

The reproduction time generating device 22 includes a preceding output time storage buffer 25, a reference fixed time offset generating unit 26, and adders A1, A2.

The preceding output time storage buffer 25 receives the output of the adder A2, stores this as the preceding output time temporarily, and outputs the stored time to the adder A1 with specific timing.

The reference fixed time offset generating unit 26 generates a reference fixed time offset and outputs the generated reference fixed time offset to the adder A1 with specific timing.

The adder A1 receives the output (the preceding output time) of the preceding output time storage buffer 25 and the output (reference fixed time offset) of the reference fixed time offset generating unit 26, adds these, and outputs the result to the adder A2.

The adder A2 receives the output of the adder A1 and the offset value (offset signal) Toffset from the reproduction time changing unit 3, adds these, and outputs the result to the time information adding device 21.

With the above configuration, if the offset value Toffset input from the reproduction time changing unit 3 is 0, the reproduction time generating device 22 adds equally-spaced offset values to the time previously output in the device 22, thereby generating reproduction times.

On the other hand, if the offset value Toffset input from the reproduction time changing unit 3 is not 0, that is, if there is a delayed offset value (+Toffset) in the reproduction time information, the reproduction time generating device 22 generates a reproduction time less led by the offset value. Therefore, in the embodiment, an offset with a delay of one unit time is input to the reproduction time generating device 22, which then generates a time delayed by one unit time in the target frame.

Moreover, the time information adding device 21 adds the time generated by the reproduction time generating device 22 to the encode data output and outputs the result. For example, in the above case, the one-unit-time-delayed time generated by the reproduction time generating device 22 is added to the encode data output. The result is output as time-information-added encoded output DOUT to an external unit, such as a reproducing unit.

### 2. Moving Image Processing Operation (Reproduction Time Changing Operation)

Next, a moving image processing operation of the moving image processing apparatus of the first embodiment will be explained.

2-1. Operation of Motion Vector Aggregating Unit

First, the operation of the motion vector aggregating unit 31 of the first embodiment will be explained. The explanation will be given with reference to the flowchart of FIG. 3.

First, the motion vector of each MB output from the moving image encoder 1 is input to the motion vector aggregating unit 31 (S1-1).

Next, the motion vector aggregating unit 31 calculates an averaged motion vector by averaging motion vector MV for each of the MBs acquired from the moving image encoder 1 (S1-2).

Then, the motion vector aggregating unit 31 outputs the averaged motion vector calculated in S1-2 to the buffer 33 and reproduction time change offset computing unit 32. The calculated averaged motion vector is stored in the buffer 33 and output to the reproduction time change offset computing unit 32 (S1-3).

2-2. Operation of Reproduction Time Offset Computing Unit

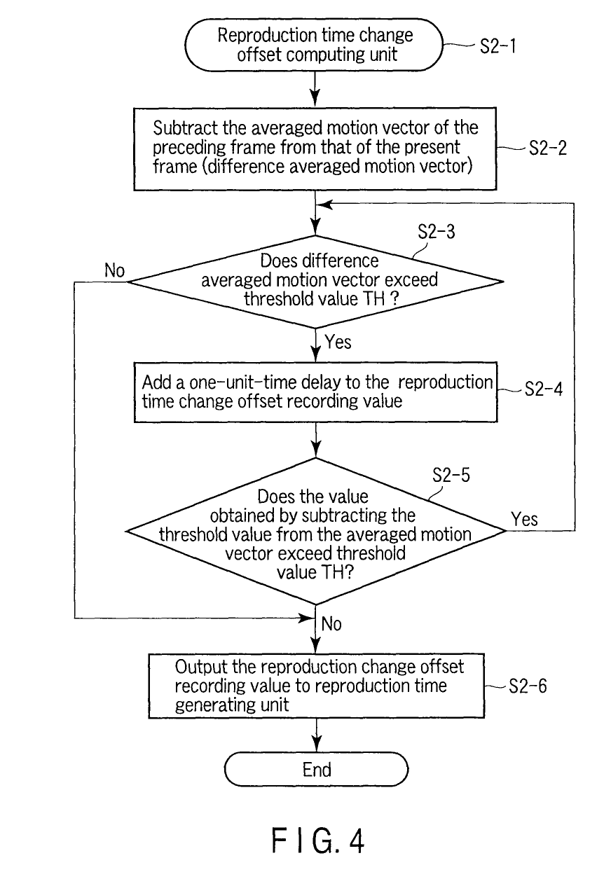

Next, the operation of the reproduction time offset computing unit 32 of the first embodiment will be explained. The explanation will be given with reference to the flowchart shown in FIG. 4.

First, the averaged motion vector input from the motion vector aggregating unit 31, the averaged motion vector of the preceding frame stored in the buffer 33, and a difference threshold value TH specified outside the apparatus are input to the reproduction time change offset computing unit 32 (S2-1).

The reproduction time change offset computing unit 32 subtracts the averaged motion vector of the preceding frame from the averaged motion vector of the present frame, thereby calculating a difference averaged motion vector (S2-2).

Then, the reproduction time change offset computing unit 32 determines whether the difference averaged motion vector calculated in S2-2 has exceeded the externally specified difference threshold value TH (S2-3).

If the difference averaged motion vector has not exceeded the difference threshold value TH externally specified (No in S2-3), control goes to steps S2-S6. For example, in the case of a rapid pan operation involving a screen movement, a frame motion vector has a very large value. Therefore, in such a case, it is determined that the difference threshold value TH has been exceeded. If the difference averaged motion vector has exceeded the externally specified difference threshold value TH (Yes in S2-3), the reproduction time change offset computing unit 32 adds, for example, a one-unit-time delay as an offset value (Toffset).

Then, the reproduction time change offset computing unit 32 subtracts the difference threshold value TH from the averaged motion vector and determines again whether the resulting value has exceeded the difference threshold value TH (S2-5).

At this time, if it has been determined that the resulting averaged motion vector has not exceeded the difference threshold value TH (No in S2-5), the reproduction time change offset computing unit 32 adds no unit-time delay and control goes to step S2-6.

If it has been determined that the resulting averaged motion vector has exceeded the difference threshold value TH (Yes in S2-5), control returns to S2-3 again.

The reproduction time change offset computing unit 32 outputs the offset value (Toffset) to the reproduction time generating device 22 and terminates the operation (S2-6).

### 3. Time-Information-Added Encoded Output DOUT

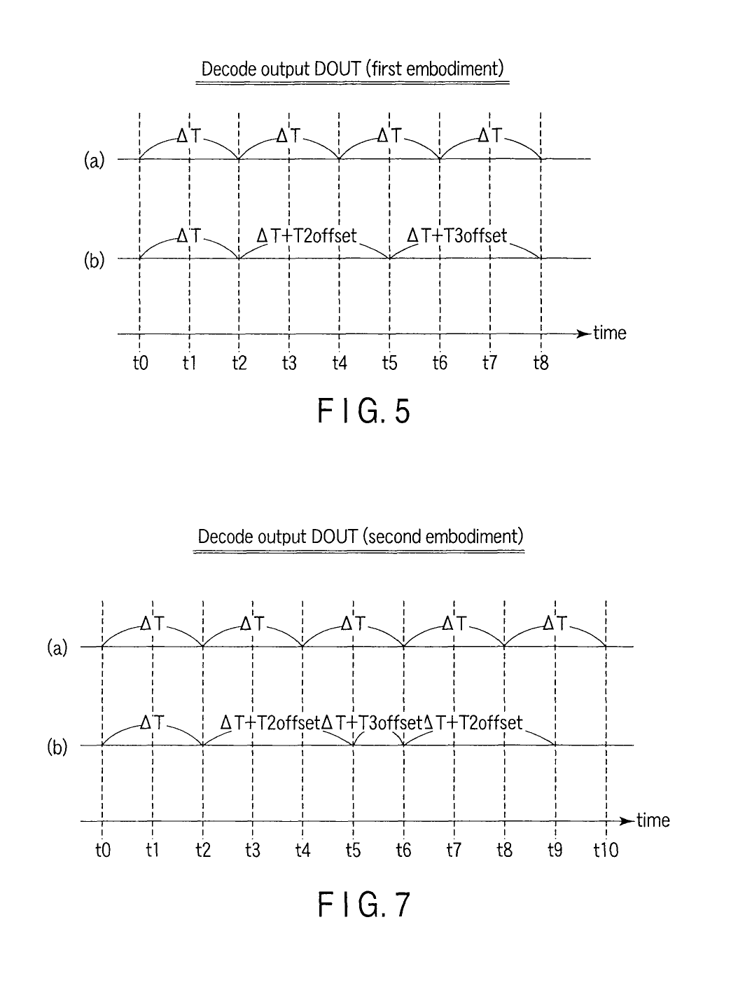

Next, a time-information-added encoded output DOUT will be explained with reference to FIG. 5. The abscissa axis (time) in FIG. 5 shows time information added to a encoded output DOUT and ΔT is an offset time generated at the reference fixed time offset generating unit 26. In FIG. 5, (a) indicates a encoded output DOUT when there is no offset information (when the offset value Toffset is 0) and (b) indicates a encoded output DOUT when there is offset information.

Suppose a time added to the encoded output DOUT when there is no offset information in (a) or when there is offset information in (b) is the same time as that at to.

Then, in (a), time t2 obtained by adding time ΔT to time t0 is added to the encoded output DOUT and the resulting DOUT is output as the next encoded output DOUT.

At this time, in (b), the offset value input from the reproduction time changing unit 3 to the time information adding unit 2 is 0 (+T1offset=0). Therefore, the time information adding unit 2 generates the present time as a reproduction time without adding equally spaced fixed offset values to the time previously output in the device, adds time t2 obtained by adding time ΔT to time t0 to the encoded output DOUT, and outputs the resulting DOUT as a encoded output DOUT.

Accordingly, the time added to the decode outputs DOUT in (a) and (b) in FIG. 5 is the same.

Then, in (a), time t4 obtained by adding time ΔT to time t2 is added to the encoded output DOUT and the resulting DOUT is output as a encoded output DOUT.

At this time, in (b), the offset value input from the reproduction time changing unit 3 to the time information adding unit 2 is, for example, a one-unit-time delay (+T2offset=one unit time). Therefore, time ΔT+T2offset obtained by adding a one-unit-time delay to ΔT is added to time t1, producing time t5.

Time t5 is added to the encoded output DOUT and the resulting DOUT is output as a encoded output DOUT.

Then, in (a), time t6 obtained by adding time ΔT to time t4 is added to the encoded output DOUT and the resulting DOUT is output as a encoded output DOUT.

In (b), the time information adding unit 2 adds to the encoded output DOUT time t8 obtained by adding time ΔT+T3offset obtained by adding the equally-spaced fixed offset values to the offset value input from the reproduction time changing unit 3 (+T3offset=one unit time) to time t5 previously output in the device and outputs the resulting DOUT as a encoded output DOUT.

More specifically, since the reproduction time changing unit 3 has input a one-unit-time delayed offset, the reproduction time generating device 22 is caused to generate a one-unit-time delayed time. Then, the time information adding device 21 adds the time generated by the reproduction time generating device 22 to the encode data. Accordingly, the one-unit-time delayed time (T3offset) generated at the reproduction time generating device 22 is added to the encode data. The resulting data is then output as a encoded output DOUT.

As described above, when moving images in a rapid pan operation involving rapid screen movements are recorded, movements whose speed exceeds a speed specified by the threshold value TH take place. However, with the configuration of the embodiment, a reproduction time to delay reproduction is generated in recording moving images and the time-information-added encoded output DOUT to which the reproduction time has been added can be output. Therefore, the decode output of the embodiment produces gradual movements, reducing a visually uncomfortable feeling.

### 4. Operational Advantages

With the moving image processing apparatus of the embodiment, at least the effects in items (1) and (2) are obtained.

(1) Even when a rapid pan operation is carried out, temporal movement-caused shakes in video shooting are uniformized effectively.

As described above, the moving image processing apparatus of the first embodiment comprises a moving image encoder 1 which outputs motion vectors MVs of encode frames, a reproduction time changing unit 3 which determines the movement amount between a moving image frame with the motion vectors and the preceding moving image frame on the basis of the motion vector MV and calculates a reproduction time offset value Toffset, a reproduction time generating device 22 which generates a reproduction time for a target frame from a reference time and the offset value Toffset of the reproduction time, and a reproduction time adding device 21 which adds the reproduction time generated at the reproduction time generating device to the moving image data output and encoded at the moving image encoder 1.

Accordingly, using the motion vectors MVs output from the moving image encoder 1, an offset value Toffset-added time (e.g., one unit time) can be added to reproduction time information used in decoding the moving images. As a result, even when moving images are recorded in a rapid pan operation involving rapid screen movements, a rapid screen movement causing a visually uncomfortable feeling can be corrected and the visual effect of uniformizing temporal movement-caused shakes in video shooting can be obtained.

For example, as shown in FIG. 5, when moving images are recorded in a rapid pan operation involving rapid screen movements, movements whose speed exceeds a speed specified by the threshold value TH take place. However, with the configuration of the first embodiment, a reproduction time to which a time to delay reproduction has been added can be output in recording moving images. Accordingly, the encoded output DOUT makes movements gradual, reducing a visually uncomfortable feeling. Moreover, the encoded output DOUT is effective in uniformizing temporal movement-caused shakes during video shooting.

(2) Production cost is reduced effectively.

In the first embodiment, when there is a movement whose speed exceeds an externally specified fixed speed (TH), moving images which are reproduced later than the time that shooting was actually performed.

Since the first embodiment requires no special device for reproduction and can obtain gradually-moving images in shooting, it is effective in reducing production cost.

### Second Embodiment

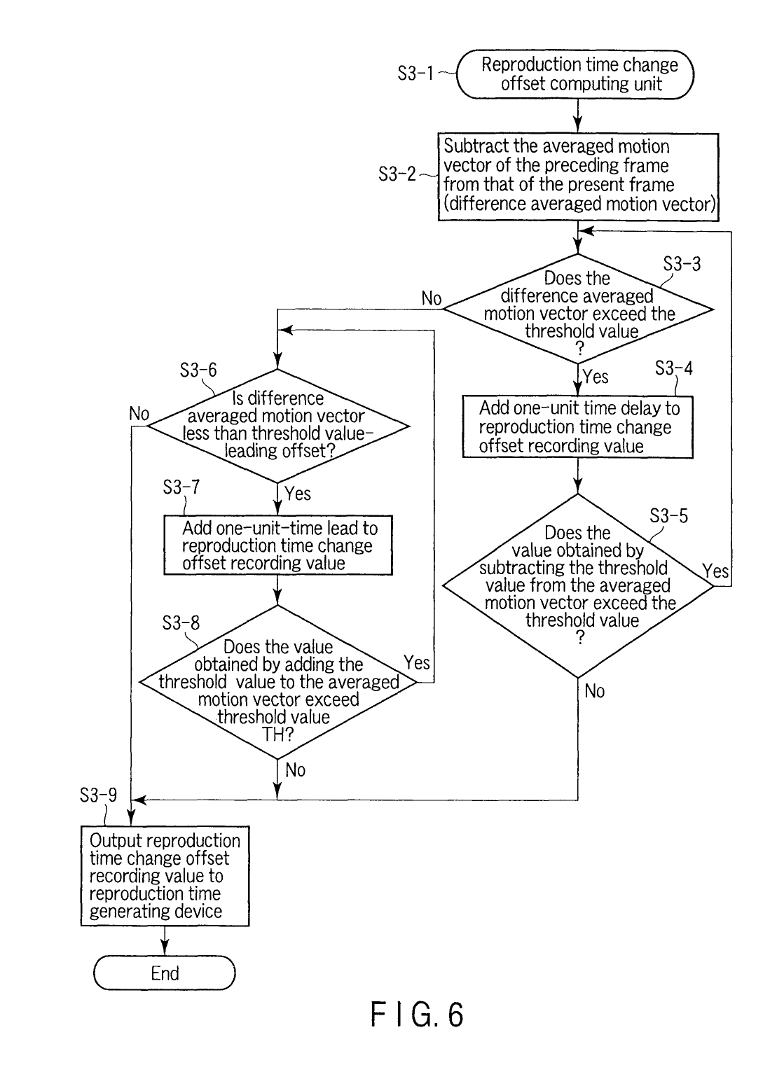

Next, a moving image processing apparatus according to a second embodiment of the invention and its processing operation will be explained with reference to FIGS. 6 and 7. The second embodiment is related to an example capable of correcting times even for much slower frame operations. In the explanation, a detailed explanation of the parts overlapping with those of the first embodiment will be omitted.

<Moving Image Processing Operation (Reproduction Time Changing Unit)>

First, the operation of a reproduction time change offset computing unit 32 of the second embodiment will be explained.

The explanation will be given with reference to the flowchart of FIG. 6.

Since the operations in S3-1 to S3-5 are the same as those in S2-1 to S2-5 of the first embodiment, a detailed explanation will be omitted. S3-6 is carried out if the calculated difference averaged motion vector has not exceeded an externally specified difference threshold value TH (No in S3-3).

That is, the reproduction time change offset computing unit 32 differs from that of the first embodiment in that it determines whether the calculated difference averaged motion vector is less than (externally specified difference threshold value TH−leading offset).

If the difference averaged motion vector is not less than (externally specified difference threshold value TH−leading offset) (No in S3-6), control goes to S3-9.

In the second embodiment, if the movement speed is slower than a specified movement speed, it is determined that the difference averaged motion vector is less than the difference threshold value. If the difference averaged motion vector is less than (externally specified difference threshold value TH−leading offset) (Yes in S3-6), the reproduction time change offset computing unit 32 adds, for example, one-unit-time lead (minus value) as an offset value Toffset. Then, the reproduction time change offset computing unit 32 outputs the offset recording value (Toffset) to the reproduction time generating device 22. Then, the reproduction time change offset computing unit 32 inputs the externally specified difference threshold value TH on the basis of the difference averaged motion vector and determines again whether the difference threshold value TH has been exceeded (S3-8).

If having determined that the added difference averaged motion vector has not exceeded the difference threshold value TH (No in S3-8), the reproduction time change offset computing unit 32 adds no unit-time delay and proceeds to S3-9.

If having determined that the added difference averaged motion vector has exceeded the difference threshold value TH (Yes in S3-8), the reproduction time change offset computing unit 32 returns to S3-6.

The reproduction time change offset computing unit 32 outputs the offset value Toffset to the reproduction time generating device 22 and terminates the process (S3-9).

<Time-Information-Added Encoded Output DOUT>

Next, the time-information-added encoded output DOUT in the above operation will be explained with reference to FIG. 7. The abscissa axis (time) in FIG. 7 shows time information added to a encoded output DOUT and ΔT is an offset time generated at the reference fixed time offset generating unit 26. In FIG. 7, (a) indicates a encoded output DOUT when there is no offset information (when the offset value is 0) and (b) indicates a encoded output DOUT when there is offset information.

Suppose a time added to the encoded output DOUT when there is no offset information in (a) or when there is offset information in (b) is the same time as that at t0.

Then, in (a), time t2 obtained by adding time ΔT to time t0 is added to the encoded output DOUT and the resulting DOUT is output as the next encoded output DOUT.

In (b), the offset value input from the reproduction time changing unit 3 to the time information adding unit 2 is 0 (+T1offset=0). Therefore, the time information adding unit 2 generates the present time as a reproduction time without adding equally spaced fixed offset values to the time previously output in the device, adds time t2 obtained by adding time ΔT to time t0 to the encoded output DOUT, and outputs the resulting DOUT as a encoded output DOUT.

Accordingly, at time t2, the time added to the decode outputs DOUT in (a) and (b) of FIG. 7 is the same.

Then, in (a), time t4 obtained by adding time ΔT to time t2 is added to the encoded output DOUT and the resulting DOUT is output as a encoded output DOUT.

In (b), the offset value input from the reproduction time changing unit 3 to the time information adding unit 2 is, for example, a one-unit-time delay (+T2offset=one unit time). Therefore, time ΔT+T2offset obtained by adding a one-unit-time delay to ΔT is added to time t2, producing time t5. Time t5 is added to the encoded output DOUT and the resulting DOUT is output as a encoded output DOUT.

Then, in (a), time t6 obtained by adding time ΔT to time t4 is added to the encoded output DOUT and the resulting DOUT is output as a encoded output DOUT.

In (b), if the offset value input from the reproduction time changing unit 3 to the time information adding unit 2 is a minus value (T3offset=−1 unit time), time t6 obtained by adding time ΔT+T3offset obtained by adding equally-spaced fixed offset values and the offset value input from the reproduction time changing unit 3 (T3offset=−1 unit time) to time t5 previously output in the device is added to the encoded output DOUT and the resulting DOUT is output as a encoded output DOUT.

More specifically, since the reproduction time changing unit 3 inputs a one-unit-time lead offset, the reproduction time generating device 22 is caused to generate a one-unit-time lead time in the target frame. Then, the time information adding device 21 adds the time generated by the reproduction time generating device 22 to the encode data. Accordingly, the one-unit-time lead time (T3offset) generated at the reproduction time generating device 22 is added to the encode data. The resulting data is output as a encoded output DOUT.

With the configuration of the second embodiment, even when operations of slow frames are performed at random, the encoded output DOUT produces gradual movements, reducing a visually uncomfortable feeling, since lead-time-added (or minus-time-added) reproduction times can be output in recording moving images

<Operational Advantages>

With the moving image processing apparatus of the second embodiment, at least the same effects as those in items (1) and (2) described above are obtained. Moreover, the effect in item (3) below is obtained.

(3) Moving images to be reproduced earlier than the time that shooting was actually performed can be created during shooting, which enables dynamic images moving at a constant speed to be processed.

With the moving image processing apparatus of the second embodiment, the reproduction time change offset computing unit 32 differs from that of the first embodiment in that it determines whether the calculated difference averaged motion vector is less than (externally specified difference threshold value TH−leading offset). Then, if the difference averaged motion vector is less than (externally specified difference threshold value TH−leading offset) (Yes in step S3-6), the reproduction time change offset computing unit 32 adds, for example, one-unit-time lead (minus value) as an offset value Toffset.

In the second embodiment, if the movement speed is slower than the specified movement speed, it has been determined that the difference averaged motion vector is less than the difference threshold value. That is, if the difference averaged motion vector has fallen below the difference motion vector of a movement distance needed in one-unit time of an offset of reproduction time, for example, one-unit-time lead (minus value) is added as the offset value Toffset. Then, the offset value Toffset is output to the reproduction time generating device 22.

Accordingly, as shown in FIG. 7, in (b), the time-information adding unit 2 generates a reproduction time by subtracting equally-spaced fixed offset values (T3offset=−1 unit time) from the time previously output in the device and outputs the reproduction time as a encoded output DOUT at reproduction time t6. More specifically, since an offset leading by one unit time is input to the reproduction time generating device 22, the device 22 is caused to generated a time led by one unit time in the target frame. Then, the time information adding unit 21 adds the time generated by the reproduction time generating device 22 to encode data. Therefore, the one-unit-time leading time generated at the reproduction time generating device (T3offset=−1 unit time) is added to the encode data DOUT and the resulting DOUT is output as a encoded output DOUT at reproduction time t6.

As described above, if the movement speed is slower than the externally specified threshold value TH, a slow frame operation is performed. Therefore, in this case, moving images can be reproduced earlier than the time that shooting was actually performed. As a result, the second embodiment has the advantage of being capable of shooting dynamic images moving at a constant speed.

By the moving image processing operation, dynamic images moving at a constant speed can be corrected even if the movement speed has fluctuated due to hand shakes in taking pictures with a handheld camera.

As described above, with the second embodiment, in the case of frames whose speed is slower than a specific speed, the reproduction time can be made earlier than the actual time. In the case of frames whose speed is faster than the specific speed, the reproduction time can be made later than the actual time. Accordingly, the second embodiment obtains a visual effect of causing the screen to visually move at a constant speed.

While in the first and second embodiments, a one-unit-time delay or a one-unit-time lead has been used as an offset value, the invention is not limited to this. For instance, the offset value may be changed as needed, such as a delay or a lead of half one unit time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving image processing apparatus comprising:
a moving image encoder which outputs the motion vectors of an encode frame;
a reproduction time changing unit which, on the basis of the motion vectors, determines a motion quantity between a moving image frame with the motion vector and the preceding moving image frame, and calculates an offset for a reproduction time;
a reproduction time generating device which generates a reproduction time of a target frame based on a reference time and the offset for the reproduction time; and
a reproduction time adding device which adds the reproduction time generated at the reproduction time generating device to moving image data encoded by the moving image encoder.

2. The moving image processing apparatus according to claim 1, wherein the reproduction time changing unit has a threshold value of a motion quantity input from the outside and, when there is a motion quantity which exceeds the input threshold value, outputs an offset value to delay the time in shooting.

3. The moving image processing apparatus according to claim 1, wherein the reproduction time changing unit includes
a vector aggregating unit which outputs an averaged motion vector obtained by averaging the input motion vectors,
a first buffer which holds the output of the motion vector aggregating unit temporarily and outputs the held output as the value at the preceding time, and
an offset computing unit which receives the output of the motion vector aggregating unit, the output of the first buffer, and the threshold value, an external fixed value, and outputs an offset value to the reproduction time generating device.

4. The moving image processing apparatus according to claim 1, wherein the reproduction time generating device includes
a second buffer which stores the preceding output time,
a reference fixed time offset generating unit which generates a reference fixed time offset,
a first adder which has the output of the second buffer and the output of the reference fixed time offset generating unit input therein and adds these outputs, and
a second adder which receives the output of the first adder and an offset value from the time information changing unit, adds these, and outputs the result to the second buffer and the outside.

5. The moving image processing apparatus according to claim 1, wherein the reproduction time generating device includes
a discrete cosine transform which performs discrete cosine transformation,
a quantization unit which quantizes the output from the discrete cosine transform, and
an coding unit which codes the output of the quantization unit and outputs the result as the moving image data to the reproduction time adding device.

6. The moving image processing apparatus according to claim 1, wherein the moving image encoder includes a motion prediction unit which receives an input signal of the moving image encoder and outputs the motion vectors.

7. A moving image processing apparatus comprising:
a moving image encoder which outputs the motion vectors of an encode frame;
a reproduction time changing unit which, on the basis of the motion vectors, determines a motion quantity between a moving image frame with the motion vector and the preceding moving image frame, and calculates an offset for a reproduction time and which has a threshold value for a motion quantity input from outside and, if a motion quantity is less than the value obtained by subtracting a leading offset from the input threshold value, outputs an offset value to set the time in shooting forward;
a reproduction time generating device which generates a reproduction time of a target frame from a reference time and the offset for the reproduction time; and
a reproduction time adding device which adds the reproduction time generated at the reproduction time generating device to moving image data encoded by the moving image encoder.

8. The moving image processing apparatus according to claim 7, wherein the reproduction time changing unit includes
a vector aggregating unit which outputs an averaged motion vector obtained by averaging the input motion vectors,
a first buffer which holds the output of the motion vector aggregating unit temporarily and outputs the held output as the value at the preceding time, and
an offset computing unit which receives the output of the motion vector aggregating unit, the output of the first buffer, and the threshold value, an external fixed value, and outputs an offset value to the reproduction time generating device.

9. The moving image processing apparatus according to claim 7, wherein the reproduction time generating device includes
a second buffer which stores the preceding output time,
a reference fixed time offset generating unit which generates a reference fixed time offset,
a first adder which has the output of the second buffer and the output of the reference fixed time offset generating unit input therein and adds these outputs, and
a second adder which receives the output of the first adder and an offset value from the time information changing unit, adds these, and outputs the result to the second buffer and the outside.

10. The moving image processing apparatus according to claim 7, wherein the reproduction time generating device includes
a discrete cosine transform which performs discrete cosine transformation,
a quantization unit which quantizes the output from the discrete cosine transform, and
an coding unit which codes the output of the quantization unit and outputs the result as the moving image data to the reproduction time adding device.

11. The moving image processing apparatus according to claim 7, wherein the moving image encoder includes a motion prediction unit which receives an input signal of the moving image encoder and outputs the motion vectors.

12. A reproduction time offset method using a reproduction time generating device with an offset computing unit, the reproduction time offset method comprising:
calculating a difference averaged motion vector by subtracting an averaged motion vector of the preceding frame from an averaged motion vector of the present frame;
determining whether the difference averaged motion vector exceeds an externally specified difference threshold value; and,
if the difference averaged motion vector exceeds the externally specified difference threshold value, adding a unit-time delay as a reproduction time change offset recording value.

13. The reproduction time offset method according to claim 12, further comprising: adding no unit-time delay if the difference averaged motion vector does not exceed the externally specified difference threshold value.

14. The reproduction time offset method according to claim 12, further comprising: determining whether the calculated difference averaged motion vector is less than (difference threshold value−leading offset).

15. The reproduction time offset method according to claim 14, further comprising: adding a unit-time lead (minus value) as a reproduction time change offset recording value if the difference averaged motion vector is less than (difference threshold value−leading offset).
